(19) United States
(12) Patent Application Publication
(10) Pub. No.: US 2024/0391432 A1
(43) Pub. Date: Nov. 28, 2024

(54) Method for Operating a Braking System of a Motor Vehicle

(71) Applicant: Robert Bosch GmbH, Stuttgart (DE)

(72) Inventors: Frank Baehrle-Miller, Schoenaich (DE); Tobias Putzer, Flein (DE)

(21) Appl. No.: 18/668,607

(22) Filed: May 20, 2024

(30) Foreign Application Priority Data
May 25, 2023 (DE) 10 2023 204 883.3

(51) Int. Cl. B60T 8/172; B60T 13/14; B60T 13/58; B60T 13/74; B60T 17/22

(52) U.S. Cl. CPC B60T 8/172; B60T 13/58; B60T 17/22; B60T 13/148; B60T 13/746; B60T 2220/04; B60T 2270/306; B60T 2270/402; B60T 2270/404

(57) ABSTRACT

A method for operating a braking system of a motor vehicle includes an electromechanical parking brake for securing the parked motor vehicle and a hydraulic braking mechanism for braking the motor vehicle. The hydraulic braking mechanism includes a brake cylinder having a displaceable piston and hydraulic fluid in order to generate a braking torque in the motor vehicle. If a malfunction in the hydraulic braking mechanism is present, an additional braking torque is generated by way of the parking brake in order to brake the motor vehicle. The additional braking torque generated by the parking brake is adjusted so that, within in a linear range, the torque depends on a pedal force exerted on the brake pedal by the driver when a brake pedal of the motor vehicle is pressed.

This application claims priority under 35 U.S.C. § 119 to patent application no. DE 10 2023 204 883.3, filed on May 25, 2023 in Germany, the disclosure of which is incorporated herein by reference in its entirety.

The disclosure relates to a method for operating a braking system of a motor vehicle. The disclosure also relates to a control device which is configured or programmed to perform this method. Finally, the disclosure relates to a braking system comprising such a control device.

### BACKGROUND

DE 10 2004 004 992 A1 discloses a braking system having a parking brake system comprising an electric brake motor, by way of which a brake piston can be displaced against a brake disk in order to generate a clamping force that immobilizes the vehicle when stationary. The parking brake system can be integrated into the hydraulic vehicle brake. During regular operation of the braking system, the brake piston is pressed against the brake disk by a hydraulic brake fluid in order to generate a braking torque.

The occurrence of a malfunction in the hydraulic vehicle brake can result in it only being able to generate a lower braking torque than requested by the driver of the motor vehicle-usually by pressing a brake pedal. This can lead to safety-critical driving situations.

Therefore, one object of the present disclosure is to create an improved method for operating a braking system of a motor vehicle, by way of which the occurrence of safety-critical driving situations can be counteracted, in particular in the event of a malfunction.

Said object is achieved by the subject matter set forth below. Preferred embodiments are the subject also set forth below.

### SUMMARY

Therefore, the basic idea of the disclosure is to generate an additional braking torque for braking the motor vehicle by way of the parking brake in the event of a malfunction of the hydraulic braking mechanism of the braking system. This torque scales essentially linearly with a braking torque requested by the driver of the vehicle. In this way, it is possible for the driver to adjust, and in particular vary, the desired braking torque by pressing the brake pedal at a specific pedal force, even in the event of a malfunction. As a result, the driver can perform the desired or required braking maneuvers even in the event of a malfunction. In this way, safety-critical driving situations are avoided or at least counteracted.

The method according to the disclosure is used to operate a braking system of a motor vehicle, which comprises an electromechanical parking brake for securing the parked motor vehicle and also a hydraulic braking mechanism for braking the motor vehicle. The hydraulic braking mechanism comprises a brake cylinder having a displaceable piston and hydraulic fluid for generating a braking torque. In the method according to the disclosure, if a malfunction in the hydraulic braking mechanism is present, an additional braking torque is generated by way of the parking brake in order to brake the motor vehicle. According to the disclosure, the additional braking torque generated by the parking brake is adjusted such that it is linearly dependent (within at least one linear range) on a pedal force exerted by the driver on a brake pedal of the motor vehicle when the brake pedal is pressed.

In a preferred embodiment, the linear relationship between the pedal force exerted and the additional braking torque generated can be stored as an analytical function or as a lookup table.

Particularly preferably, the top of the linear range can be limited by an upper limit value of the pedal force. The upper limit value can be stored in a memory unit of the control device performing the method according to the disclosure.

According to one advantageous embodiment of the method according to the disclosure, when the brake pedal is pressed at a pedal force that is greater than the upper limit value, a braking torque can be generated by the parking brake, the value of which torque corresponds to that generated when the brake pedal is pressed at a pedal force at the upper limit value.

It is particularly advantageous for the parking brake to generate an additional braking torque of approximately 0.1 m/s² when the brake pedal is pressed at a pedal force of approximately 10N. Alternatively or additionally, a braking torque of approximately 2 m/s² can be generated by the parking brake when the brake pedal is pressed at approximately 200N.

According to an advantageous embodiment of the method according to the disclosure, a “malfunction” in the context of the method according to the disclosure is present if the suction of hydraulic fluid from a hydraulic fluid reservoir into the brake cylinder by way of a hydraulic support mechanism of the braking system is made more difficult or—in extreme cases—even impossible compared to a nominal state without malfunction. Such a hydraulic support mechanism can, e.g., be an ESP system which can increase the driving stability of the vehicle through targeted brake applications on individual wheels of the vehicle, and thus counteract a loss of control by the driver. The hydraulic support mechanism can-in particular with the aid of a suitable fluid pump—deliver hydraulic fluid from the hydraulic fluid reservoir into the brake cylinder to generate a targeted brake application, in particular by way of suction, so that the hydraulic pressure of the hydraulic fluid in the brake cylinder is temporarily increased. The result is the desired temporary increase in braking force exerted by the piston on a brake disk.

Particularly preferably, the suction of hydraulic fluid can be made difficult or impossible, so a malfunction in the content of the disclosure is present if an electric drive for displacing the piston has failed, and the adjustable piston is in a position where a fluidic connection between the hydraulic fluid reservoir and the brake cylinder is prevented. Such a fluidic interruption is necessary to ensure that the movement of the piston towards the brake disk causes the desired pressure increase in the hydraulic fluid. Without said fluidic interruption, the hydraulic fluid would be “shoved” into the hydraulic fluid reservoir by the piston movement without increasing the pressure.

If, during regular operation of the hydraulic braking mechanism, the piston is displaced from a rest position to an active position where it exerts a braking force on the brake disk, so a fluidic connection between the hydraulic fluid reservoir and the inside of the brake cylinder is specifically interrupted in this active position. If the piston remains in the active position due to a malfunction, then the interrupted fluid connection between the inside of the piston and the hydraulic fluid reservoir makes it difficult or even impossible to suction the hydraulic fluid, as described hereinabove. In this case, the hydraulic support mechanism cannot fulfill its proper function, so the electromechanical parking brake is activated, and an additional braking torque is generated according to the method according to the disclosure.

Alternatively or additionally, the suction of hydraulic fluid can also be made more difficult or impossible, so a malfunction in the context of the disclosure is present if an actual viscosity of the hydraulic fluid is greater than a specified maximum value.

In another preferred embodiment of the method according to the disclosure, a malfunction in the context of the disclosure presented herein may be present if what is referred to as an actual system stiffness of the braking system, which depends on the displaced hydraulic volume of hydraulic fluid when the piston is displaced and on the braking force generated by way of the displaced hydraulic volume, is less than a minimum permissible threshold value. The system stiffness is largely determined by the physical properties of the hydraulic fluid and can, e.g., be negatively influenced by water in the hydraulic fluid, or if the temperature of the hydraulic fluid is too high, as well as by leakage effects. The system stiffness can be determined by determining a pressure increase in the hydraulic fluid as a function of the hydraulic fluid volume moved when the piston is displaced.

In a further preferred embodiment, a malfunction can also occur if an operating temperature of the braking system exceeds a (first) predetermined maximum value. Such overheating of the braking system can lead to reduced performance in terms of the maximum braking torque that can be generated by the hydraulic braking mechanism. The operating temperature can be estimated or calculated using a suitable operating temperature model.

According to an advantageous embodiment, a malfunction in the context of the method according to the disclosure is present if an operating temperature of the braking system exceeds a (second) predetermined maximum value for a specified minimum period of time. In this embodiment, the second predetermined maximum value is particularly preferably smaller than the first predetermined maximum value. Such a temperature increase in the braking system over the said minimum duration can also lead to reduced performance with regard to the maximum braking torque that can be generated by the hydraulic braking mechanism. The operating temperature can be estimated or calculated using a suitable operating temperature model.

A malfunction can also be present if the fill level of the hydraulic fluid reservoir is lower than a specified minimum value.

The present disclosure also relates to a control device for a motor vehicle. The control device according to the disclosure is configured/programmed to perform the method according to the disclosure presented above. The advantages of the method according to the disclosure explained hereinabove are therefore applicable to the control device according to the disclosure.

The disclosure also relates to a braking system for a motor vehicle. The braking system comprises a hydraulic braking mechanism for braking the motor vehicle, which mechanism comprises a brake cylinder having a displaceable piston and hydraulic fluid for generating a braking torque in the motor vehicle. The braking system also comprises an electromechanical parking brake to secure the vehicle when it is parked. The braking system further comprises a control device according to the disclosure, as presented hereinabove, for controlling the hydraulic braking mechanism and for controlling the electromechanical parking brake. Therefore, the advantages of the method according to the disclosure explained hereinabove are also applicable to the braking system according to the disclosure.

In a preferred embodiment of the braking system according to the disclosure, said system comprises a hydraulic support mechanism, in particular an ESP system, for increasing or decreasing a hydraulic pressure of the hydraulic fluid present in the brake cylinder.

In another preferred embodiment, the hydraulic braking mechanism can comprise an electric drive for displacing the piston.

Further important features and advantages of the disclosure will emerge from the drawings and from the associated figure description with reference to the drawings.

It is understood that the features specified hereinabove and those yet to be explained hereinafter can be used not only in the combination indicated in each case, but also in other combinations or on their own, without departing from the scope of the present disclosure.

### BRIEF DESCRIPTION OF THE DRAWINGS

Preferred exemplary embodiments of the disclosure are illustrated in the drawings and explained in more detail in the subsequent description.

Schematically shown are:

FIG. 1 is a schematic diagram and, by way of example, the structure of a braking system according to the disclosure.

FIG. 2 is a diagram showing the functional dependence of, in the event of a malfunction of the parking brake 8, the additional braking torque generated by pressing the brake pedal, said torque being a function of the pedal force exerted on the brake pedal.

### DETAILED DESCRIPTION

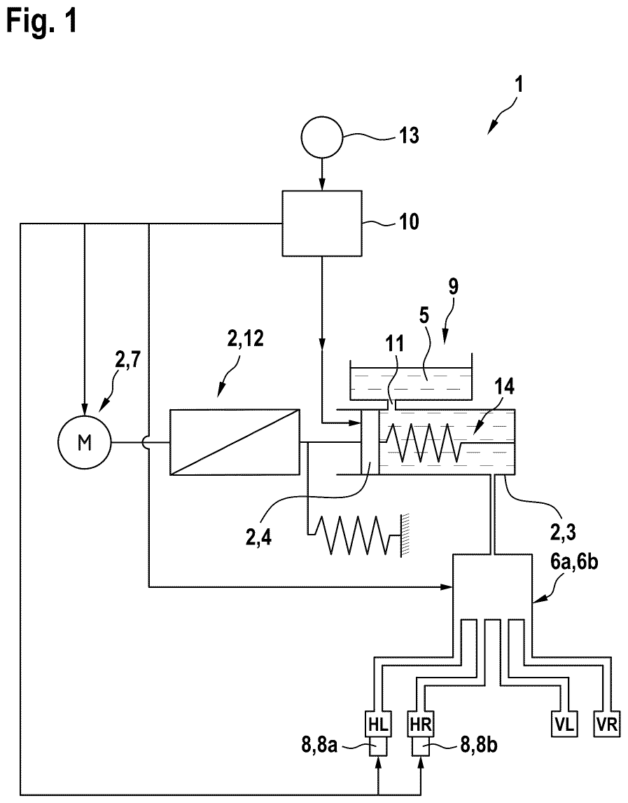

FIG. 1 shows an example of a braking system 1 according to the disclosure in the form of a circuit diagram. The braking system 1 therefore comprises a hydraulic braking mechanism 2 for braking the motor vehicle. For this purpose, the braking mechanism 1 comprises a brake cylinder 3 having a displaceable piston 4 and hydraulic fluid 5 for generating a braking torque in the vehicle. The inside 14 of the piston 4 communicates 11 fluidically via a fluidic connection 11 with a hydraulic fluid reservoir 9, in which hydraulic fluid 5 is stored.

The braking system 1 further comprises an electromechanical parking brake 8 for securing the vehicle when it is parked. The braking system further comprises a control device 10 according to the disclosure, as presented hereinabove, for controlling the hydraulic braking mechanism 2 and for controlling the electromechanical parking brake 8, specifically both during nominal operation of the braking system 1 and when a malfunction of the braking mechanism 2 occurs, as explained hereinafter. By pressing a brake pedal 13 of the motor vehicle which interacts with the control device 10, the driver of the motor vehicle can request a specific braking torque from the braking system 1, which depends on a pedal force PK the driver exerts on the brake pedal 13 when the latter is pressed.

As FIG. 1 also illustrates, the hydraulic braking mechanism 2 can comprise an electric drive 7 for displacing the piston 4. In particular, the electric drive 7 can be drive-connected to the piston 4 via a transmission 12 of the hydraulic braking mechanism 2. By way of the transmission 12, a rotary movement of a drive shaft of the electric drive 7 can be transferred or converted into a linear movement of the piston 4.

According to FIG. 1, the braking system 1 can also comprise a hydraulic support mechanism 6, e.g. in the form of an ESP system 6a. The support mechanism 6 or ESP system 6a can also be controlled by the control device 10. By way of the hydraulic support mechanism 6 or the ESP system 6a, the hydraulic fluid 5 present in the brake cylinder 3 can, via suction, be delivered to the four wheel brakes VL, VR, HL, HR of the vehicle (not shown in detail in FIG. 1) in order to generate the desired braking torque. The hydraulic support mechanism 6 or the ESP system 6a can be equipped with a hydraulic pump (not shown) for suction. The hydraulic support mechanism 6 or the ESP system 6a can therefore be used to both increase and decrease the braking torque generated. A change in the hydraulic pressure is accompanied by a change in the braking torque exerted by the braking system 1 on the four wheel brakes VL, VR, HL, HR of the motor vehicle.

The hydraulic support mechanism 6 or the ESP system 6a can increase the driving stability of the motor vehicle through targeted brake applications using the four wheel brakes VL, VR, HL, HR on individual wheels (not shown) of the motor vehicle and thus counteract a loss of control by the driver.

The suction of hydraulic fluid 5 by the hydraulic support mechanism 6 or the ESP system 6a can then be made more difficult or impossible, so a malfunction in the context of the disclosure is present if an electric drive 7 for displacing the piston 4 has failed and the displaceable piston 4 is in a position where a fluidic connection 11 of the hydraulic fluid reservoir 9 to the brake cylinder 3 is interrupted or prevented. Such a fluidic interruption is necessary and therefore desirable to ensure that the movement of the piston 4 towards the brake disk causes the pressure of the hydraulic fluid to build.

The mechanical parking brake 8 comprises two actuators 8a, 8b (only roughly indicated in FIG. 1), which act directly on the wheel brakes HL, HR and are associated with the left and right rear wheels of the motor vehicle.

The control device 10 of the braking system 1 is configured or programmed to perform the method according to the disclosure presented above. The method according to the disclosure is explained hereinafter by way of example.

According to the method, if there is a malfunction in the hydraulic braking mechanism 2, an additional braking torque ZBM is generated by the parking brake 8 to brake the vehicle.

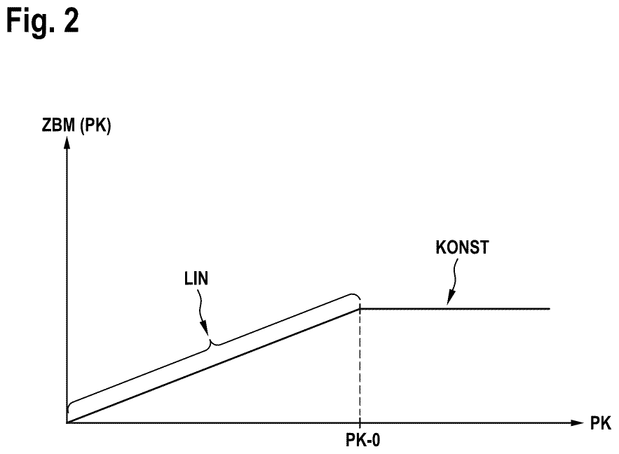

The additional braking torque ZBM generated by the parking brake 8 is adjusted by appropriate control by way of the control device 10 so that, within a linear range LIN, it is linearly dependent on the pedal force PK exerted on the brake pedal 13 by the driver when the latter is pressed. This is shown by way of example and in a highly simplified form by the diagram in FIG. 2, which illustrates the functional dependency of the additional braking torque ZBM generated by the parking brake 8 on the pedal force PK, i.e., ZBM=ZBM(PK) in the event of a malfunction.

Within the linear range LIN of the functional dependency ZBM=ZBM(PK) applies, so ZBM=m*PK, where m is the gradient factor. The linear relationship between the additional braking torque ZBM generated by the parking brake 8 in the event of a malfunction and the pedal force PK exerted by the driver in the linear range LIN can be stored as an analytical function or as a lookup table in a memory unit of the control device 10.

As illustrated in the diagram in FIG. 2, the top of the linear range LIN can be limited by an upper limit value PK−O of the pedal force PK−O. The upper limit value PK−O can also be stored in a memory unit of the control device 10.

When the brake pedal 13 is pressed at a pedal force PK of 10N, the parking brake 8 can, e.g., generate an additional braking torque of 0.1 m/s². Accordingly, when the brake pedal is pressed at a pedal force PK of 200N, a braking torque of 2 m/s² can be generated by the parking brake 8.

In the example, the pedal force of 200N represents the upper limit value PK−O. When the brake pedal 13 is pressed at a pedal force PK that is greater than the upper limit value PK−O, a CONSTANT additional braking torque ZBM is generated by the parking brake 8 according to FIG. 2 in the event of a malfunction, which corresponds to that generated when the brake pedal 13 is pressed at a pedal force PK equal to the upper limit value PO−K. This range at a constant additional braking torque ZBM following the linear range LIN is indicated as “KONST” in FIG. 2. The following therefore applies to the “KONST” range: ZBM(PK)=ZBM(PK−O) for PK>PK−O.

In the following, various possible malfunctions in the braking mechanism 2, and thus in the braking system 1, are presented by way of example. In the context of the method according to the disclosure, these malfunctions lead to the generation of an additional braking torque by the electromechanical parking brake 8 of the braking system 1.

In the context of the present disclosure, a malfunction may be present if suction of the hydraulic fluid 5 from the hydraulic fluid reservoir 9 and into the brake cylinder 3 by way of the hydraulic support mechanism 6 of the braking system 1 is more difficult or—in extreme cases—even impossible compared to a nominal state without malfunction. This may be the case if, e.g., the electric drive 7 for displacing the piston 4 has failed due to a fault and the displaceable piston 4 is also in a position where a fluidic connection 11 between the hydraulic fluid reservoir 9 and the brake cylinder 3 is prevented.

However, said suction of hydraulic fluid 5 can also be made more difficult or impossible if the viscosity of the hydraulic fluid becomes very high due to the low temperature, so that a viscous and therefore less flowable hydraulic fluid is formed.

In the context of the disclosure presented herein, a malfunction may furthermore be present if an actual system stiffness of the braking system 1 is less than a minimum permissible threshold value. The system stiffness is largely determined by the hydraulic fluid and can, e.g., be negatively influenced by water in the hydraulic fluid or an excessively high hydraulic fluid temperature as well as by leakage effects. Said system stiffness depends on the displaced hydraulic volume of hydraulic fluid 5 when the piston 4 is displaced, and on the braking force generated by the displaced hydraulic volume and can therefore be determined—with the aid of a conventional sensor system installed in the braking system 1 (not shown in FIG. 1)—by determining a pressure increase in the hydraulic fluid as a function of a hydraulic volume of hydraulic fluid 5 moved when the piston 4 is displaced.

Furthermore, a malfunction can also occur if an operating temperature of the braking system 1 exceeds a predetermined first maximum value.

In the context of the method according to the disclosure, a malfunction may also be present if an operating temperature of the braking system 1 exceeds a second specified maximum value for a predetermined minimum period of time. In this case, the second predetermined maximum value is smaller than the first predetermined maximum value.

What is claimed is:

1. A method for operating a braking system of a motor vehicle, wherein the braking system comprising (i) an electromechanical parking brake configured to secure the parked motor vehicle, and (ii) a hydraulic braking mechanism configured to brake the motor vehicle, and wherein the hydraulic braking mechanism includes a brake cylinder having a displaceable piston and hydraulic fluid in order to generate a braking torque, the method comprising:
if a malfunction of the hydraulic braking mechanism is present, generating an additional braking torque by way of the parking brake in order to brake the motor vehicle; and
adjusting the additional braking torque generated by the parking brake so that, within in a linear range, the torque depends on a pedal force exerted on the brake pedal by the driver when a brake pedal of the motor vehicle is pressed.

2. The method according to claim 1, wherein the linear relationship between the pedal force exerted and the additional braking torque generated is stored as an analytical function or as a lookup table.

3. The method according to claim 1, wherein the top of the linear range is limited by an upper limit value of the pedal force.

4. The method according to claim 1, wherein the upper limit value is approximately 0.2 kN.

5. The method according to claim 3, wherein:
when the brake pedal is pressed at a pedal force which is greater than the upper limit value, a constant additional braking torque is generated by the parking brake, and
the value of the constant additional braking torque corresponds to that generated when the brake pedal is pressed by a pedal force at the upper limit value.

6. The method according to claim 1 wherein:
in the event of a malfunction, an additional braking torque of 0.1 m/s² is generated by the parking brake when the brake pedal is pressed at a pedal force of 10 N, and/or
in the event of a malfunction, an additional braking torque of 2 m/s² is generated by the parking brake when the brake pedal is pressed at a pedal force of 200 N.

7. The method according to claim 1, wherein:
a malfunction is present if, compared to a nominal state without malfunction, it is more difficult or impossible to suction the hydraulic fluid from a hydraulic fluid reservoir into the brake cylinder by way of a hydraulic support mechanism of the braking system.

8. The method according to claim 7, wherein:
the suction of hydraulic fluid is made difficult or impossible, so a malfunction is present if an electric drive of the hydraulic braking mechanism for displacing the piston has failed and the piston is also in a position where a fluidic connection between the hydraulic fluid reservoir and the brake cylinder is interrupted.

9. The method according to claim 7, wherein:
the suction of hydraulic fluid is difficult or impossible, so a malfunction is present if the actual viscosity of the hydraulic fluid is greater than a specified maximum value.

10. The method according to claim 1, wherein:
a malfunction is present if an actual system stiffness of the braking system, which depends on the displaced hydraulic volume of hydraulic fluid when the piston is displaced and on the braking force generated by way of the displaced hydraulic volume, is less than a minimum permissible threshold value, and
the system stiffness is determined by determining a pressure increase in the hydraulic fluid as a function of a hydraulic volume of hydraulic fluid moved when the piston is displaced.

11. The method according to claim 1, wherein:
a malfunction is present if an operating temperature of the braking system exceeds a first predetermined maximum value.

12. The method according to claim 11, wherein:
a malfunction is present if an operating temperature of the braking system exceeds a second predetermined maximum value for a specified minimum period of time, which is smaller than the first predetermined maximum value.

13. A control device for a motor vehicle, wherein the control device is configured and/or programmed to perform the method according to claim 1.

14. A braking system for a motor vehicle, comprising:
a hydraulic braking mechanism configured to brake the motor vehicle, wherein the hydraulic braking mechanism includes a brake cylinder having a displaceable piston and hydraulic fluid in order to generate a braking torque in the motor vehicle;
an electromechanical parking brake configured to secure the motor vehicle when it is parked; and
a control device according to claim 13 for controlling the hydraulic braking mechanism and the electromechanical parking brake.

15. The braking system according to claim 14, wherein:
the braking system comprises a hydraulic support mechanism configured to increase or decrease a hydraulic pressure of the hydraulic fluid present in the brake cylinder, and/or
the hydraulic braking mechanism includes an electric drive configured to displace the piston.

16. The braking system according to claim 15, wherein the hydraulic support mechanism is an ESP system.
